(19) United States
(12) Patent Application Publication
(10) Pub. No.: US 2004/0180169 A1
(43) Pub. Date: Sep. 16, 2004

(54) Pressure sensitive adhesive constructions of light weight paper and methods of making the same

(76) Inventors: Jennifer Slabe, Willoughby, OH (US); Peter Robin von Kleist, Alta Loma, CA (US)

Correspondence Address: Heidi A. Boehlefeld, Renner, Otto, Boisselle & Sklar, LLP, Nineteenth Floor, 1621 Euclid Avenue, Cleveland, OH, 44115-2191, US

(21) Appl. No.: 10/780,458

(22) Filed: Feb. 17, 2004

Related U.S. Application Data
(60) Provisional application No. 60/448,056, filed on Feb. 18, 2003.

(51) Int. Cl. B32B 9/00

(52) U.S. Cl. 428/40.1

(57) ABSTRACT

This invention relates to an adhesive article comprising a pressure sensitive adhesive having a first and second surface and a lightweight paper adhered to the first surface. The article may also include a release liner. The adhesive articles may be directly applied in decorative or artistic projects without the need for an external glue. Those projects include the use of these papers in scrapbooks, decorations for wall boards, etc.

This application claims priority from provisional application Serial No. 60/448,056, filed Feb. 18, 2003.

### TECHNICAL FIELD OF THE INVENTION

This invention relates to adhesive articles and methods of making the same. More specifically, the adhesive article is a pressure sensitive adhesive article of light weight paper.

### BACKGROUND OF THE INVENTION

Specialty papers have been used in decorative and artistic applications. These specialty papers are typically light weight papers. The light weight papers have been used to add color or textures to applications. The papers are generally applied with external glue to hold them in place. Light weight paper by its nature is porous and fragile. The paper must be applied carefully to achieve the desired effects. It is desirable to have a self adhering article of light weight paper.

Pressure sensitive adhesives have been applied to facestocks to produce adhesive articles. The adhesive is typically coated onto paper or polymeric film substrate or facestock. The adhesive is cured, e.g. solvent or water is removed, to form the adhesive article.

One problem for adhesive articles from light weight paper involves direct coating of the pressure sensitive adhesive. The adhesive migrates through the paper because it is porous. Another problem with light weight paper is the increased adhesion of the adhesive to traditional liners. Also the light weight paper is difficult to handle during manufacture because it breaks, tears and/or wrinkles easily during machine operations.

A need exists for adhesive article made from light weight paper. It is desirable to have a light weight paper that has the advantages of pressure sensitive adhesive constructions.

### SUMMARY OF THE INVENTION

This invention relates to an adhesive article comprising a pressure sensitive adhesive layer having a first and second surface and a lightweight paper adhered to the first surface of the pressure sensitive adhesive layer. These articles may also include a release liner releasably adhered to the pressure sensitive adhesive layer. The adhesive articles may be directly applied in decorative or artistic projects without the need for external glue. The adhesive articles of the present invention are particularly useful in those projects that include the use of light weight papers in scrapbooks, decorations for wall boards, etc.

In another embodiment, the invention relates to an adhesive article comprising an acrylic pressure sensitive adhesive layer having a first and second surface and a paper on the first surface that has a weight of less that 100 grams per square meter. These adhesive articles may have a release liner releasably adhered to the pressure sensitive adhesive.

In another embodiment, the invention relates to a method of preparing an adhesive article comprising the steps of (A) providing a pressure sensitive adhesive having a first and second surface and (B) laminating a light weight paper to the first surface of the pressure sensitive layer.

In another embodiment, the invention relates to a method of making an adhesive article comprising the steps of (A) providing a transfer tape comprising a pressure sensitive adhesive layer having a first and second surface and a release liner releasably adhered to each of the first and second surfaces of the adhesive layer, (B) removing the release liner adhered to the first surface of the pressure sensitive adhesive layer, and (C) laminating the first surface of the pressure sensitive adhesive layer to a lightweight paper.

### BRIEF DESCRIPTION OF THE DRAWINGS

FIG. 1a is a cross sectional view of a pressure sensitive adhesive article of a light weight paper.

FIG. 1b is a cross sectional view of a pressure sensitive adhesive article of a light weight paper where the adhesive layer partially covers the paper.

FIG. 2a is a cross sectional view of a pressure sensitive adhesive article of a light weight paper that includes a release liner.

FIG. 2b is a cross sectional view of a pressure sensitive adhesive article of a light weight paper that includes a release liner, wherein the adhesive partially covers the paper.

FIGS. 3a to 3c are cross sectional views of a intermediate and final adhesive articles of the present method of making the light weight paper adhesive articles.

FIG. 4 is a cross sectional view of a pressure sensitive adhesive article of light weight paper and a polymeric film.

### DETAILED DESCRIPTION OF THE PREFERRED EMBODIMENTS

As described herein, an adhesive article comprises a pressure sensitive adhesive layer having a first and second surface and a lightweight paper adhered to the first surface of the pressure sensitive adhesive layer.

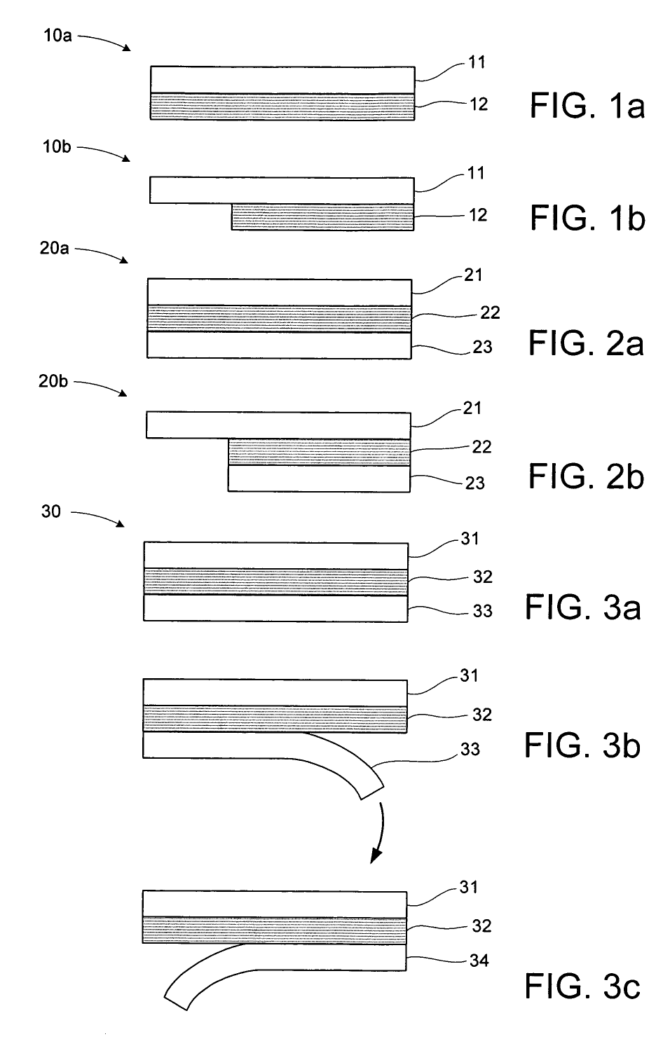

FIG. 1a is a schematic illustration of a side view of an adhesive construction 10a of the present invention. The adhesive construction 10a comprises a pressure sensitive adhesive layer 12 having an upper surface and a lower surface and a light weight paper layer 11 having an upper surface and a lower surface wherein the lower surface of paper layer 11 is adhered to the upper surface of pressure sensitive adhesive layer 12. Adhesive layer 12 is a continuous layer that completely covers the lower surface of paper layer 11.

FIG. 1b is an illustration of a side view of adhesive construction 10b that comprises light weight paper layer 11 that is partially covered on its lower surface by the upper surface of pressure sensitive adhesive layer 12. Adhesive layer 12 may cover a portion of the lower surface of paper layer 11 in a continuous layer or in a discontinuous pattern of stripes or other geometries.

FIG. 2a is an illustration of a side view of adhesive construction 20a that comprises light weight paper layer 21 having an upper surface and a lower surface; pressure sensitive adhesive layer 22 having an upper surface and a lower surface wherein the upper surface of adhesive layer 22 is adhered to and completely covers the lower surface of paper layer 21; and release liner 23 having an upper surface and a lower surface wherein the upper surface of release liner 23 is releasably adhered to the lower surface of adhesive layer 22.

FIG. 2b is an illustration of a side view of adhesive construction 20b that comprises light weight paper layer 21 that is partially covered on its lower surface by the upper surface of pressure sensitive adhesive layer 22. Adhesive layer 22 may cover a portion of the lower surface of paper layer 21 in a continuous layer or in a discontinuous pattern of stripes or other geometries. Release liner 23 is releasably adhered to adhesive layer 22.

The adhesive articles have a pressure sensitive adhesive (PSA) layer. In one embodiment, the pressure sensitive adhesive is tacky at ambient temperatures. The pressure sensitive adhesive layer is typically present at a coat weight of about 5 to about 40, or from about 10 to about 35, or from about 15 to about 30 grams per square meter (gsm). Here and elsewhere in the specification and claims, the range and ratio limits may be combined.

The pressure sensitive adhesives useful in the present invention include rubber based adhesives, acrylic adhesives, vinyl ether adhesives, silicone adhesives, and mixtures of two or more thereof. Included are the pressure sensitive adhesive materials described in “Adhesion and Bonding”, Encyclopedia of Polymer Science and Engineering, Vol. 1, pages 476-546, Interscience Publishers, 2nd Ed. 1985, the disclosure of which is hereby incorporated by reference. The pressure sensitive adhesive materials that are useful may contain as a major constituent an adhesive polymer such as acrylic type polymers, block copolymers, natural, reclaimed or styrene butadiene rubbers, tackified natural or synthetic rubbers, random copolymers of ethylene and vinyl acetate, ethylene-vinyl-acrylic terpolymers, polyisobutylene, poly(vinyl ether), etc. The pressure sensitive adhesive materials are typically characterized by glass transition temperatures in the range of about −70° C. to about 10° C.

In one embodiment, the pressure sensitive adhesive is an acrylic adhesive such as those composed of homopolymers, copolymers or cross-linked copolymers of at least one acrylic or methacrylic component, for example acrylic esters such as methyl acrylate, ethyl acrylate, n-propyl acrylate, isopropyl acrylate, n-butyl acrylate, isobutyl acrylate, tert-butyl acrylate, amyl acrylate, hexyl acrylate, octyl acrylate, 2-ethylhexyl acrylate, undecyl acrylate or lauryl acrylate, and optionally as a comonomer, a carboxyl-containing monomer such as (meth)acrylic acid [the expression “(meth)acrylic” acid denotes acrylic acid and methacrylic acid], itaconic acid, crotonic acid, maleic acid, maleic anhydride or butyl maleate, a hydroxyl-containing monomer such as 2-hydroxyethyl(meth)acrylate, 2-hydroxypropyl(meth)acrylate or allyl alcohol, an amido-containing monomer such as (meth)acrylamide, N-methyl(meth)acrylamide, or N-ethyl-(meth)acrylamide, a methylol group-containing monomer such as N-methylol(meth)acrylamide or dimethylol(meth)acrylamide, an amino-containing monomer such as aminoethyl(meth)acrylate, dimethylaminoethyl(meth)acrylate or vinylpyridine, or a non-functional monomer such as ethylene, propylene, styrene or vinyl acetate; mixtures thereof, and adhesives containing at least one such adhesives as a main component.

In one embodiment, acrylic adhesive base resins comprise multi-polymers based upon a mixture of monomers and typified as being composed of lower glass transition temperature esters. Such acrylic adhesives provide sufficient viscoelastic flow to assure adequate build-up of adhesion.

Acrylic based pressure sensitive adhesive include those taught in U.S. Pat. No. 5,164,444 (Bernard), U.S. Pat. No. 5,623,011 (Bernard) and U.S. Pat. No. 6,306,982 (Lee). The adhesive can also be rubber-based such as those taught in U.S. Pat. No. 5,705,551 (Sasaki et al.). It can also be a radiation curable mixture of monomers with initiators and other ingredients such as those taught in U.S. Pat. No. 5,232,958 (Ang) and U.S. Pat. No. 5,232,958 (Mallya et al.). The disclosures of these patents and the pending application as they relate to acrylic adhesives are hereby incorporated by reference. The pressure sensitive adhesives include emulsion, solvent based and hot melt pressure sensitive adhesives.

Another useful acrylic PSA comprises a blend of emulsion polymer particles with dispersion tackifier particles as generally described in Example 2 of U.S. Pat. No. 6,306,982. The polymer is made by emulsion polymerization of 2-ethylhexyl acrylate, vinyl acetate, dioctyl maleate, acrylic and methacrylic comonomers as described in U.S. Pat. No. 5,164,444 (Bernard), resulting in the latex particle size of about 0.2 microns in weight average diameters and a gel content of about 60%.

In one embodiment, the adhesives may generally be classified into the following categories:

(a) Random copolymer adhesives such as those based upon acrylate and/or methacrylate copolymers, a-olefin copolymers, silicone copolymers, chloroprene/acrylonitrile copolymers, and the like.

(b) Block copolymer adhesives including those based upon linear block copolymers (i.e., A-B and A-B-A type), branched block copolymers, star block copolymers, grafted or radial block copolymers, and the like, and

(c) Natural and synthetic rubber adhesives.

A description of useful pressure-sensitive adhesives may be found in Encyclopedia of Polymer Science and Engineering, Vol. 13. Wiley-Interscience Publishers (New York, 1988). Additional description of useful pressure-sensitive adhesives may be found in Encyclopedia of Polymer Science and Technology, Vol. 1, Interscience Publishers (New York, 1964).

Commercially available pressure-sensitive adhesives are suitable for use in the present invention. Examples of these adhesives include the hot melt pressure-sensitive adhesives available from H.B. Fuller Company, St. Paul, Minn. as HM-1597, HL-2207-X, HL-2115×, HL-2193-X. Other useful commercially available pressure-sensitive adhesives include those available from Century Adhesives Corporation, Columbus, Ohio.

Conventional PSAs, including silicone-based PSAs, rubber-based PSAs, and acrylic-based PSAs are useful. Another commercially available example of a hot melt adhesive is H2187-01, sold by Ato Findley, Inc., of Wauwatusa, Wis. In addition, rubber based block copolymer PSAs described in U.S. Pat. No. 3,239,478 (Harlan) also can be utilized in the coextruded adhesive constructions of the present invention, and this patent is hereby incorporated by a reference for its disclosure of such hot melt adhesives.

In another embodiment, the pressure sensitive adhesive utilized in the present invention comprises rubber based elastomer materials such as linear, branched, graft or radial block copolymers represented by the diblock structures A-B, the triblock A-B-A, the radial or coupled structures (A-B)ₙ, and combinations of these where A represents a hard thermoplastic phase or block that is non-rubbery or glassy or crystalline at room temperature but fluid at higher temperatures, and B represents a soft block which is rubbery or elastomeric at service or room temperature. These thermoplastic elastomers may comprise from about 75% to about 95% by weight of rubbery segments and from about 5% to about 25% by weight of non-rubbery segments.

The non-rubbery segments or hard blocks comprise polymers of mono- and polycyclic aromatic hydrocarbons, and more particularly vinyl-substituted aromatic hydrocarbons that may be monocyclic or bicyclic in nature. Particularly useful rubbery blocks or segments are polymer blocks of homopolymers or copolymers of aliphatic conjugated dienes. Rubbery materials such as polyisoprene, polybutadiene, and styrene butadiene rubbers may be used to form the rubbery block or segment. Rubbery segments including polydienes and saturated olefin rubbers of ethylene/butylene or ethylene/propylene copolymers can be used. The latter rubbers may be obtained from the corresponding unsaturated polyalkylene moieties such as polybutadiene and polyisoprene by hydrogenation thereof.

The block copolymers of vinyl aromatic hydrocarbons and conjugated dienes that may be utilized include any of those that exhibit elastomeric properties. The block copolymers may be diblock, triblock, multiblock, starblock, polyblock or graftblock copolymers. Throughout this specification, the terms diblock, triblock, multiblock, polyblock, and graft or grafted-block with respect to the structural features of block copolymers are to be given their normal meaning as defined in the literature such as in the Encyclopedia of Polymer Science and Engineering, Vol. 2, (1985) John Wiley & Sons, Inc., New York, pp. 325-326, and by J. E. McGrath in Block Copolymers, Science Technology, Dale J. Meier, Ed., Harwood Academic Publishers, 1979, at pages 1-5.

Such block copolymers may contain various ratios of conjugated dienes to vinyl aromatic hydrocarbons including those containing up to about 40% by weight of vinyl aromatic hydrocarbon. Accordingly, multi-block copolymers may be utilized which are linear or radial symmetric or asymmetric and which have structures represented by the formulae A-B, A-B-A, A-B-A-B, B-A-B, (AB)_{0,1,2} . . . BA, etc., wherein A is a polymer block of a vinyl aromatic hydrocarbon or a conjugated diene/vinyl aromatic hydrocarbon tapered copolymer block, and B is a rubbery polymer block of a conjugated diene.

The block copolymers may be prepared by any of the well-known block polymerization or copolymerization procedures including sequential addition of monomer, incremental addition of monomer, or coupling techniques as illustrated in, for example, U.S. Pat. Nos. 3,251,905; 3,390,207; 3,598,887; and 4,219,627. As well known, tapered copolymer blocks can be incorporated in the multi-block copolymers by copolymerizing a mixture of conjugated diene and vinyl aromatic hydrocarbon monomers utilizing the difference in their copolymerization reactivity rates. Various patents describe the preparation of multi-block copolymers containing tapered copolymer blocks including U.S. Pat. Nos. 3,251,905; 3,639,521; and 4,208,356, the disclosures of which are hereby incorporated by reference.

Conjugated dienes that may be utilized to prepare the polymers and copolymers are those containing from 4 to about 10 carbon atoms and more generally, from 4 to 6 carbon atoms. Examples include from 1,3-butadiene, 2-methyl-1,3-butadiene (isoprene), 2,3-dimethyl-1,3-butadiene, chloroprene, 1,3-pentadiene, 1,3-hexadiene, etc. Mixtures of these conjugated dienes also may be used. Particularly useful conjugated dienes are isoprene and 1,3-butadiene.

Examples of vinyl aromatic hydrocarbons that may be utilized to prepare the copolymers include styrene and the various substituted styrenes such as o-methylstyrene, p-methylstyrene, p-tert-butylstyrene, 1,3-dimethylstyrene, alpha-methylstyrene, beta-methylstyrene, p-isopropylstyrene, 2,3-dimethylstyrene, o-chlorostyrene, p-chlorostyrene, o-bromostyrene, 2-chloro4-methylstyrene, etc. A particularly useful vinyl aromatic hydrocarbon is styrene.

Many of the above-described copolymers of conjugated dienes and vinyl aromatic compounds are commercially available. The number average molecular weight of the block copolymers, prior to hydrogenation, is from about 20,000 to about 500,000, preferably from about 40,000 to about 300,000.

The average molecular weights of the individual blocks within the copolymers may vary within certain limits. In most instances, the vinyl aromatic block will have a number average molecular weight in the order of about 2000 to about 125,000, and preferably between about 4000 and 60,000. The conjugated diene blocks either before or after hydrogenation will have number average molecular weights in the order of about 10,000 to about 450,000 and more preferably from about 35,000 to 150,000.

Also, prior to hydrogenation, the vinyl content of the conjugated diene portion generally is from about 10% to about 80%, and in one embodiment, the vinyl content is about 25% to about 65%, particularly about 35% to about 55% when it is desired that the modified block copolymer exhibit rubbery elasticity. The vinyl content of the block copolymer can be measured by means of nuclear magnetic resonance.

Specific examples of diblock copolymers include styrene-butadiene (SB), styrene-isoprene (SI), and the hydrogenated derivatives thereof. Examples of triblock polymers include styrene-butadiene-styrene (SBS), styrene-isoprene-styrene (SIS), alpha-methylstyrene-butadiene-alpha-methylstyrene, and alpha-methylstyrene-isoprene alpha-methylstyrene. Examples of commercially available block copolymers useful as the adhesives in the present invention include Kraton polymers available from Shell Chemical Company, such as Kraton D1101, D1107P, D1111, D1112P, D1113P, D1117P, and D1320. Vector 4111 is an SIS block copolymer available from Dexco of Houston Tex.

Upon hydrogenation of the SBS copolymers comprising a rubbery segment of a mixture of 1,4 and 1,2 isomers, a styrene-ethylene-butylene styrene (SEBS) block copolymer is obtained. Similarly, hydrogenation of an SIS polymer yields a styrene-ethylene propylene-styrene (SEPS) block copolymer.

The selective hydrogenation of the block copolymers may be carried out by a variety of well known processes including hydrogenation in the presence of such catalysts as Raney nickel, noble metals such as platinum, palladium, etc., and soluble transition metal catalysts. Suitable hydrogenation processes which can be used are those wherein the diene-containing polymer or copolymer is dissolved in an inert hydrocarbon diluent such as cyclohexane and hydrogenated by reaction with hydrogen in the presence of a soluble hydrogenation catalyst. Such procedures are described in U.S. Pat. Nos. 3,113,986 and 4,226,952, the disclosures of which are incorporated herein by reference. Such hydrogenation of the block copolymers which are carried out in a manner and to extent as to produce selectively hydrogenated copolymers having a residual unsaturation content in the polydiene block of from about 0.5% to about 20% of their original unsaturation content prior to hydrogenation.

In one embodiment, the conjugated diene portion of the block copolymer is at least 90% saturated and more often at least 95% saturated while the vinyl aromatic portion is not significantly hydrogenated. Particularly useful hydrogenated block copolymers are hydrogenated products of the block copolymers of styrene—isoprene-styrene such as a styrene-(ethylene/propylene)-styrene block polymer. When a polystyrene-polybutadiene-polystyrene block copolymer is hydrogenated, it is desirable that the 1,2-polybutadiene to 1,4-polybutadiene ratio in the polymer is from about 30:70 to about 70:30. When such a block copolymer is hydrogenated, the resulting product resembles a regular copolymer block of ethylene and 1-butene (EB). As noted above, when the conjugated diene employed as isoprene, the resulting hydrogenated product resembles a regular copolymer block of ethylene and propylene (EP).

A number of selectively hydrogenated block copolymers are available commercially from Shell Chemical Company under the general trade designation “Kraton G”. One example is Kraton G1652, which is a hydrogenated SBS triblock comprising about 30% by weight of styrene end blocks and a midblock, which is a copolymer of ethylene and 1-butene (EB). A lower molecular weight version of G1652 is available from Shell under the designation Kraton G1650. Kraton G1651 is another SEBS block copolymer that contains about 33% by weight of styrene. Kraton G1657 is an SEBS diblock copolymer that contains about 13% w styrene. This styrene content is lower than the styrene content in Kraton G1 650 and Kraton G1652.

In another embodiment, the selectively hydrogenated block copolymer is of the formula: Bₙ(AB)₀Aₚ; wherein n=0 or 1; o is 1 to 100; p is 0 or 1; each B prior to hydrogenation is predominantly a polymerized conjugated diene hydrocarbon block having a number average molecular weight of about 20,000 to about 450,000; each A is predominantly a polymerized vinyl aromatic hydrocarbon block having a number average molecular weight of from about 2000 to about 115,000; the blocks of A constituting about 5% to about 95% by weight of the copolymer; and the unsaturation of the block B is less than about 10% of the original unsaturation. In other embodiments, the unsaturation of block B is reduced upon hydrogenation to less than 5% of its original value, and the average unsaturation of the hydrogenated block copolymer is reduced to less than 20% of its original value.

The block copolymers may also include functionalized polymers such as may be obtained by reacting an alpha, beta-olefinically unsaturated monocarboxylic or dicarboxylic acid reagent onto selectively hydrogenated block copolymers of vinyl aromatic hydrocarbons and conjugated dienes as described above. The reaction between the carboxylic acid reagent in the graft block copolymer can be effected in solutions or by a melt process in the presence of a free radical initiator.

The preparation of various selectively hydrogenated block copolymers of conjugated dienes and vinyl aromatic hydrocarbons which have been grafted with a carboxylic acid reagent is described in a number of patents including U.S. Pat. Nos. 4,578,429; 4,657,970; and 4,795,782, and the disclosures of these patents relating to grafted selectively hydrogenated block copolymers of conjugated dienes and vinyl aromatic compounds, and the preparation of such compounds are hereby incorporated by reference. U.S. Pat. No. 4,795,782 describes and gives examples of the preparation of the grafted block copolymers by the solution process and the melt process. U.S. Pat. No. 4,578,429 contains an example of grafting of Kraton G1652 (SEBS) polymer with maleic anhydride with 2,5-dimethyl-2,5-di(t-butylperoxy) hexane by a melt reaction in a twin screw extruder. (See Col. 8, lines 40-61.)

Examples of commercially available maleated selectively hydrogenated copolymers of styrene and butadiene include Kraton FG1901X, FG1921X, and FG1924X from Shell, often referred to as maleated selectively hydrogenated SEBS copolymers. Kraton FG1901 X contains about 1.7% by weight bound functionality as succinic anhydride and about 28% by weight of styrene. Kraton FG1921X contains about 1% by weight of bound functionality as succinic anhydride and 29% by weight of styrene. Kraton FG1924X contains about 13% by weight styrene and about 1% by weight bound functionality as succinic anhydride.

Useful block copolymers also are available from Nippon Zeon Co., 2-1, Marunochi, Chiyoda-ku, Tokyo, Japan. For example, Quintac 3530 is available from Nippon Zeon and is believed to be a linear styrene-isoprene-styrene block copolymer.

The polymer film materials and adhesive compositions used to form the constructions of the present invention may be neat, or they may be emulsions or solvent-based. Emulsion and solvent-based acrylic based PSAs are known and described in, for example, U.S. Pat. No. 5,639,811 and 5,164,444, respectively, and these patents are hereby incorporated by reference for such disclosures.

When emulsions of the film materials and/or adhesive compositions are used, the water may be removed in an extruder by using the process described and claimed in U.S. Pat. No. 5,716,669 (LaRose et al).

Rubber based adhesives can also be used as the pressure-sensitive adhesive. They may require a detackifying resin that has moieties that are compatible with the rubber based adhesive.

The use of a tackifier is optional. Conventional tackifiers such as hydrogenated rosin esters may be used. The use of a tackifier enables achievement of increased levels of adhesion and peel value, but its use is not necessary to recovery of available peel. Since 90% recovery is achieved in most cases, the use of a tackifier is determined by the need to increase the overall level of adhesion and release value.

Pressure-sensitive adhesives in accordance with the invention may include from about 1 to about 30% detackifying resin on a dry weight basis and, more preferably, from about 4% to about 20%. (Unless otherwise indicated, all weight percentages are on a dry weight basis of the final pressure-sensitive adhesive.) The detackifying particle may be used in amounts ranging from about 1% to about 15% by weight or from about 3% to about 12%. If a tackifier is used, it may be added in amounts ranging up to about 30% by weight or up to about 20% by weight. The tackifier may be used in the pressure-sensitive adhesives of the present invention to increase the ultimate adhesion or release value in the same manner as used in conventional pressure-sensitive adhesives. The adhesive base resin forms the remainder of the pressure-sensitive adhesive and it ranges in amount from about 25% to about 98% by weight. If a tackifier is not used, the adhesive base resin ranges from about 45% to about 98% by weight of the pressure-sensitive adhesive.

In one embodiment, the adhesive layer comprises a pressure sensitive adhesive AT-1 available from Avery Dennison Corp.

As described above, the adhesive articles are prepared using a light weight paper. Light weight papers are those papers having a weight of less that 150 grams per square meter. These papers are often referred to as specialty papers. In one embodiment, the light weight paper has a weight of less than about 150, or less than about 125, or less than about 100, or less that 80 grams per square meters.

In one embodiment, the light weight paper includes handmade or machine made papers. The light weight paper is composed of various fibers. Non-wood fibers usable in the present invention include bast fibers such as paper mulberry, paper bush, ganpi, flax, hemp, kenaf, ramie, jute and Sunn hemp; seed fibers such as cotton and cotton linters; leaf fibers such as Manila hemp, sisal and esparto; and stem fibers such as bamboo, rice straw, wheat straw and sugarcane bagasse. In particular, paper mulberry, paper bush, kenaf, Manila hemp, sisal, cotton and cotton linters are useful because they have long fibers and they are capable of improving the extensibility and strength of the paper. Pulps of short fibers obtained from broad leaf trees such as birch, beech, maple, elm and chestnut trees are also usable in combination with the trees of long fibers. In one embodiment, the paper contains at least a major amount of non-wood fibers. In another embodiment, the paper contains greater than 60%, or greater than 70% or greater than 80% by weight of non-wood fibers.

Examples of light weight papers are described in the following table.

| | | | | | Machine |
|---|---|---|---|---|---|
| | | | | | or |
| | WEIGHT | | FIBER CONTENT | pH | Handmade |
| EGYPT | | | | | |
| Papyrus (light and dark) | varies | | 100% papyrus | 10.3 | Handmade |
| INDIA | | | | | |
| Text & Cover | varies | | 100% cotton with inclusions | 4.5 | Handmade |
| Silkscreen | varies | | 100% cotton rag | 7.0 | Machine |
| JAPAN | | | | | |
| Ginwashi | 34 | g/m2 | 90% manila hemp 10% kozo | 6.7 | Machine |
| Hosyo professional | 70 | g/m2 | 100% wood pulp | 5.9 | Handmade |
| Lace-Heavyweight | 30 | g/m2 | 60% kozo 40% wood pulp | 7.0 | Handmade |
| Lace-Lightweight | 12 | g/m2 | 90% kozo 10% wood pulp | 7.0 | Handmade |
| Lace-Ogura | 27 | g/m2 | 100% manila | 7.0 | Machine |
| Momi | 75 | g/m2 | 40% kozo 60% wood pulp | 6.0 | Handmade |
| Momi.Metallics | 75 | g/m2 | 90% pulp 10% manila | 7.0 | Machine |
| Momi-Pearlized | 75 | g/m2 | 100% wood pulp | 7.0 | Machine |
| Sunomi (gold & silver) | 34 | g/m2 | kozo & wood pulp | 7.0 | Handmade |
| Turnip | 48 | g/m2 | 50% kozo 50% turnip/melon | 7.0 | Handmade |
| | | | leaves | | |
| Unryu (w/gold & silver flecks | 20 | g/m2 | 30% wood pulp 70% rayon | acidic | Machine |
| Yuzen | 38 | g/m2 | 70% kozo 15% esparto 15% | 6.5 | Machine |
| | | | wood | | |
| Watermark | 58 | g/m2 | 95% wood pulp 5% rayon | 6.8 | Machine |
| NEPAL | | | | | |
| Lokta | varies | | 100% Daphne | 6.8 | Handmade |
| PHILIPPINES | | | | | |
| Banana bark natural | 125-130 | g/m2 | abaca and banana | X | Handmade |
| Banana mat | 110-115 | g/m2 | abaca and banana | X | Handmade |
| Black-solid | 110-120 | g/m2 | abaca and banana | X | Handmade |
| Embossed | varies | | 100% salago | 8.6 | Handmade |
| Fishnet | 80+ | g/m2 | 100% salago w/cotton thread | X | Handmade |
| Grassmat | | | abaca fiber | 6.4 | Handmade |
| Lupa | varies | | 100% salago w/mix of coconut, | X | Handmade |
| | | | rice hulls, or abaca | | |
| Salago | varies | | 100% salago w/mix of coconut, | 8.4 | Handmade |
| | | | rice hulls, or abaca | | |
| Salago with banana bark | varies | | 100% salago with banana bark | 7.0 | Handmade |
| | | | inclusions | | |
| Silk Screen | 125+ | g/m2 | abaca and salago | X | Machine |
| Stardust | 115-120 | g/m2 | abaca and salago | X | Handmade |
| TAIWAN | | | | | |
| Crushed leather | 100 | g/m2 | 100% wood pulp | 5.7 | Machine |
| Grass | 33 | g/m2 | 100% kozo | 6.0 | Handmade |
| Granite | 110 | g/m2 | 100% wood pulp | X | Machine |
| Kaleidoscope | 35 | g/m2 | 100% kozo | X | Handmade |
| Lace-Lightweight | 26 | g/m2 | kozo and abaca | 6.0 | Handmade |
| Momi-Lightweight | 30 | g/m2 | kozo and wood pulp | 6.0 | Handmade |
| Pearlized | 63 | g/m2 | 100% wood pulp | 6.0 | Machine |
| THAILAND | | | | | |
| Banana | 40 | g/m2 | 50% kozo 50% banana fiber | 5.6 | Machine |
| Banana Mash | varies | | 50% koto 40% banana bark 10% | 7.0 | Machine |
| | | | leaves | | |
| Batik | 40 | g/m2 | 100% kozo | X | Handmade |
| Bird's Nest | varies | | coconut hair & tree debris | X | Handmade |
| Cal Ling | 65 | g/m2 | 100% kozo w/fabric additives | 8.4 | Machine |
| Confetti | 40 | g/m2 | 50% kozo 50% recycled paper | X | Machine |
| Crumpled | 30 | g/m2 | 100% kozo | 6.9 | Machine |
| Embossed | 100 | g/m2 | 100% kozo | 7.7 | Handmade |
| Garden BKTG-2770, −83 | 200 | g/m2 | 100% kozo | 7.1 | Handmade |
| BKTG-2784, 2786, 2788 | 100 | g/m2 | 100% kozo | X | Handmade |
| Laces | varies | | 100% kozo | X | Machine |
| Mango | 35 | g/m2 | 60% kozo 40% mango leaf | 6.0 | Machine |
| Marbled | 30 | g/m2 | 60% kozo 40% bamboo pulp | 6.5 | Machine |
| Marbled Momi | 30 | g/m2 | 60% kozo 40% bamboo pulp | 6.9 | Machine |
| Mulberry bleached | 45 | g/m2 | 100% kozo | 8.0 | Machine |
| Mulberry unbleached | 45 | g/m2 | 90% kozo 10% bamboo pulp | 7.0 | Machine |
| Mulberry unbleached w/mica | 40 | g/m2 | 100% kozo w/mica & paper | 7.0 | Machine |
| | | | Inclusion | | |
| Naturals | varies | | 50% kozo 50% recycled paper | 8.4 | Machine |
| News | 40 | g/m2 | 70% kozo 30% torn newspaper | acidic | Machine |
| Soft metallics | varies | | 100% kozo | 8.3 | Machine |
| Unryu BKTU-2000 | 10 | g/m2 | 100% kozo | 6.9 | |
| BKTU-2001 | 40 | g/m2 | 100% kozo | 7.0 | Machine |
| BKTU-2002 | 80 | g/m2 | 100% kozo | 6.8 | Machine |
| BKTU-2005, 2020 | 18 | g/m2 | 100% kozo | 7.0 | Machine |
| BKTU.2062 2063, 2064 | 45 | g/m2 | 100% kozo | 7.0 | Handmade |
| All other colors | 25 | g/m2 | 100% kozo | 7.0 | Machine |
| Unryu Heavyweight Crinkled | 80 | g/m2 | 100% kozo | 7.0 | Machine |
| Unryu Reversible | 65 | g/m2 | 100% kozo | 7.0 | Machine |
| Unryu Soft | 35 | g/m2 | 100% kozo | 7.0 | Machine |
| U.S.A. | | | | | |
| Marbled BKMA-5050 & | 104 | g/m2 | 90% wood pulp 10% post | 7.0 | Machine |
| BKMA-5052 | | | consumer waste | | |
| Marbled-All others | 104 | g/m2 | 90% wood pulp 10% post | 5.0 | Machine |
| | | | consumer waste | | |
| Silkscreens BKUS5000 | 65 | g/m2 | 100% wood pulp - vellum | x | Machine |

| | | | | |
|---|---|---|---|---|
| BKUS5002-BKUS5004 | varies | 100% cotton rag | x | Handmade |
| BKUS5006-BKUS5008 | varies | 100% wood pulp | x | Machine |
| BKUS5010-BKUS5018 | varies | 100% Daphne | x | Handmade |

In one embodiment, the pressure sensitive adhesive has at least one surface covered by a release liner. Generally, the release surface of the release liners have a release value of less than about 90, or less than about 80, or less than about 70 grams per square meter. The release liners are generally known as easy release liners. These liners generally have a release value of about 35 to about 95, or from about 40 to about 90 grams per square meter. The release value is obtained by the Tappi test method TM-8.

The release liner may comprise a backing liner and a layer of a cured release coating composition adhered to one side of the backing liner. The release coating is in contact with at least one adhesive layer when the release liner is releasably adhered to the pressure sensitive adhesive layer. The release coating composition can be any release coating composition known in the art provided the release liners have the proper peel strengths as described herein. Silicone release coating compositions are useful, and any of the silicone release coating compositions that are known in the art can be used. The major component of the silicone release coating is a polyorganosiloxane and, more often, a polydimethylsiloxane. The silicone release coating composition may be room temperature cured, thermally cured, or radiation cured. Generally, the room temperature and thermally curable compositions comprise at least one polyorganosiloxane and at least one catalyst (or curing agent) for the polyorganosiloxane. These compositions may also contain at least one cure accelerator and/or adhesion promoter (sometimes referred to as an anchorage additive). As is known in the art, some materials have the capability of performing both functions, i.e., the capability of acting as a cure accelerator to increase the rate, reduce the curing temperature, etc., and also as an adhesion promoter to improve bonding of the silicone composition to the backing liner.

The release coating composition is applied to the backing liner and cured using known techniques. The application techniques include gravure, reverse gravure, offset gravure, roller coating, brushing, knife-over roll, metering rod, reverse roll coating, doctor knife, dipping, die coating, spraying, curtain coating, and the like. The coat weight is generally in the range of about 0.1 gsm to about 10 gsm or more, and in one embodiment about 0.3 gsm to about 2 gsm. In one embodiment, the thickness or caliper of the resulting release-coated liner may range from about 4 mils to about 10 mils (about 100 to about 250 microns), and in one embodiment from about 4 mils to about 6 mils (about 100 to about 150 microns).

The backing liner may comprise paper, polymer film, or a combination thereof. Any suitable paper, polymer films, or combinations thereof, can be used as the backing liner. Paper liners are particularly useful because of the wide variety of applications in which they can be employed. Paper is also relatively inexpensive and has desirable properties such as antiblocking, antistatic, dimensional stability, and can potentially be recycled. Any type of paper having sufficient tensile strength to be handled in conventional paper coating and treating apparatus can be employed as the liner. Although paper of any weight can be employed as the liner material, paper having basis weights in the range of about 30 to about 120 lb/ream are useful. In one embodiment, the release liner may be a silicon coated paper such as 30# SCK release liner from Avery Dennison Corp. having a release value of 20 grams per square meter.

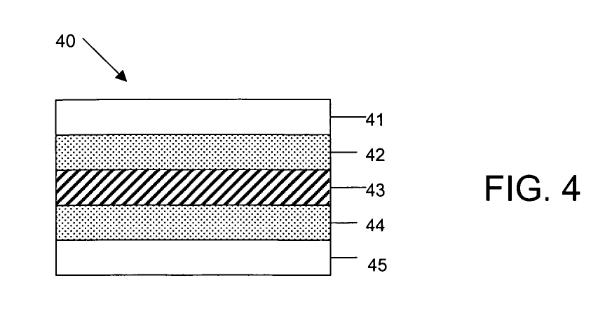

In one embodiment, illustrated in FIG. 4, the adhesive construction includes a polymeric film adhered to the light weight paper. In some applications, the addition of the polymeric film to the adhesive construction provides a more durable construction and/or a construction that is easier for the user to handle without tearing the light weight paper. The polymeric film may be a transparent film. FIG. 4 is an illustration of a side view of adhesive construction 40 that comprises light weight paper layer 41 having an upper surface and a lower surface; a first adhesive layer 42 having an upper surface and a lower surface wherein the upper surface of adhesive layer 42 is adhered to the lower surface of light weight paper layer 41; a polymeric film layer 43 having an upper surface and a lower surface wherein the upper surface of polymeric film layer 43 is adhered to the lower surface of adhesive layer 42; and a second adhesive layer 44 having an upper surface and a lower surface wherein the upper surface of adhesive layer 44 is adhered to the lower surface of polymeric film layer 43. A release liner 45 may be releasably adhered to the lower surface of adhesive layer 44. Adhesive layer 42 may be the same as or different from adhesive layer 44. Polymeric film layer 42 may comprise, for example, a biaxially oriented polypropylene (BOPP) film. In one example, the polymeric film is a 2 mil thick, transparent BOPP film.

The adhesive articles of the present invention may be made by laminating an adhesive layer to a light weight paper substrate. The adhesive layer is prepared as a transfer tape having two release liners. The adhesive is coated onto one of the liners and dried. The adhesive layer is then formed into a transfer tape by adding the other release liner. The release values of the liners are not the same. The release value of one liner is two or more times the release value of the other liner. This release value difference ensures that the adhesive layer will separate and stay with the liner having the stronger release. The release value of the liner that is removed and discarded during manufacture of the adhesive article is lower than the release value of the other liner. A useful ratio of release values of the two liners is about 2:1 to about 5:1. The transfer tape is stripped on one liner and then laminated to the light weight paper as is known to those in the art.

During the lamination of the light weight paper to the adhesive layer, the web guides that control the tension on the web of paper are set below about 15, or below about 10, or below about 5 pounds per square inch. Tensions of about 2 pounds per square inch are useful. This low web tension prevents or reduces damage or wrinkling of the light paper web during manufacture of the present adhesive articles.

Referring to FIG. 3a, transfer tape 30 has release liner 31 having a release value from about 30 to about 90 (or about 45 to about 60) grams per square meter (e.g. 88# acid free silicone coated release liner having a release value of 30 grams per square meter). Release liner 31 is releasably adhered to pressure sensitive adhesive 32. Pressure sensitive 32 is also adhered to release liner 33 having a release value of about 5 to about 35 (or about 15 to about 25) grams per square meter (e.g. 30# SCK release liner having a release value of 20 grams per square meter). In FIG. 3b, release liner 33 is peeled from the transfer tape exposing one surface of adhesive layer 32. In FIG. 3c, light weight paper 34 is laminated to the exposed surface of pressure sensitive adhesive 32.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. An adhesive article comprising a pressure sensitive adhesive layer having a first surface and second surface and a lightweight paper adhered to the first surface.

2. The article of claim 1 wherein the paper has a weight of less than about 150 grams per square meter.

3. The article of claim 1 wherein the paper has a weight of less than about 125 grams per square meter.

4. The article of claim 1 wherein the paper contains a major amount of non-wood fibers.

5. The article of claim 1 wherein the pressure sensitive adhesive layer comprises a rubber based adhesive, an acrylic adhesive, a vinyl ether adhesive, a silicone adhesive, or mixtures of two or more thereof.

6. The article of claim 1 wherein the pressure sensitive adhesive layer comprises an acrylic pressure sensitive adhesive.

7. The article of claim 1 wherein the pressure sensitive adhesive layer has a coat weight up to about 50 grams per square meter.

8. The article of claim 1 wherein the pressure sensitive adhesive layer has a coat weight from about 5 to about 35 grams per square meter.

9. The article of claim 1 further comprising a release liner releasably adhered to the second surface of the pressure sensitive adhesive layer.

10. The article of claim 1 wherein the release liner has a release value of from about 30 to about 90 grams per square meter.

11. An adhesive article comprising an acrylic pressure sensitive adhesive layer having a first surface and a second surface, and a light weight paper adhered to the first surface, wherein the paper has a weight of less that 100 grams per square meter.

12. The article of claim 11 wherein the paper contains a major amount of non-wood fibers.

13. The article of claim 11 wherein the pressure sensitive adhesive layer has a coat weight up to about 50 grams per square meter.

14. The article of claim 11 wherein the pressure sensitive adhesive layer has a coat weight of about 5 to about 35 grams per square meter.

15. The article of claim 11 further comprising a release liner releasably adhered to the second surface of the pressure sensitive adhesive layer.

16. The article of claim 15 wherein the release liner has a release value of about 30 to about 90 grams per square meter.

17. An adhesive article comprising:
a light weight paper layer having an upper surface and a lower surface;
a first adhesive layer having an upper surface and a lower surface wherein the upper surface of adhesive layer is adhered to the lower surface of light weight paper layer;
a polymeric film having an upper surface and a lower surface wherein the upper surface of polymeric film is adhered to the lower surface of the adhesive layer; and
a second adhesive layer having an upper surface and a lower surface wherein the second adhesive comprises a pressure sensitive adhesive and the upper surface of second adhesive layer is adhered to the lower surface of polymeric film.

18. The adhesive article of claim 17 wherein the paper has a weight of less than about 150 grams per square meter.

19. The adhesive article of claim 17 wherein the paper has a weight of less than about 125 grams per square meter.

20. The adhesive article of claim 17 further comprising a release liner releasably adhered to the lower surface of the second adhesive layer.

21. A method of preparing an adhesive article comprising the steps of (A) providing a pressure sensitive adhesive layer having a first surface and a second surface and (B) laminating a light weight paper to the first surface of the pressure sensitive adhesive layer.

22. The method of claim 21 wherein the laminating step is carried out under a web guide tension of less than 15 pounds per square inch.

23. The method of claim 21 wherein the laminating step is carried out at a web guide tension of less that 10 pounds per square inch.

24. The method of claim 21 wherein the paper has a weight of less than about 150 grams per square meter.

25. The method of claim 21 wherein the paper contains a major amount of non-wood fibers.

26. The method of claim 21 wherein the pressure sensitive adhesive layer comprises a rubber based adhesive, an acrylic adhesive, a vinyl ether adhesive, a silicone adhesive, or mixtures of two or more thereof.

27. The method of claim 21 wherein the pressure sensitive adhesive layer comprises an acrylic pressure sensitive adhesive.

28. The method of claim 21 wherein the pressure sensitive adhesive layer has a coat weight up to about 50 grams per square meter.

29. The method of claim 21 wherein the pressure sensitive adhesive layer is provided in a double sided tape having a first and second release liner adhered to each of the first and second surfaces of the pressure sensitive adhesive layer respectively, wherein the method further comprises the step of removing the first release liner adhered to the first surface of the pressure sensitive adhesive layer prior to the laminating step.

30. A method of making an adhesive article comprising the steps of (a) providing a transfer tape comprising a pressure sensitive adhesive layer having a first surface and a second surface and a first and second release liner releasably adhered to each of the first and second surfaces of the pressure sensitive adhesive layer respectively, (B) removing the first release liner adhered to the first surface of the pressure sensitive adhesive layer, and (C) laminating the first surface of the pressure sensitive adhesive layer to a paper having a weight of less than 150 grams per square meter.

31. The method of claim 30 wherein the first release liner adhered to the first surface of the pressure sensitive adhesive layer has a release value of about 30 to about 90 pounds per square inch.

32. The method of claim 30 wherein the second release liner adhered to the second surface of the pressure sensitive adhesive layer has a release value of about 5 to about 30 pounds per square inch.

33. The method of claim 30 wherein the paper has a weight of less that about 125 grams per square meter.

34. The method of claim 30 wherein the paper contains a major amount of non-wood fibers.

35. The method of claim 30 wherein the pressure sensitive adhesive layer comprises a silicone-based, rubber-based, or acrylic-based adhesive.

36. The method of claim 30 wherein the pressure sensitive adhesive layer comprises an acrylic pressure sensitive adhesive.

37. The method of claim 30 wherein the pressure sensitive adhesive layer has a coat weight up to about 50 grams per square meter.
